(19) United States
(12) Patent Application Publication
(10) Pub. No.: US 2026/0239395 A1
(43) Pub. Date: Aug. 13, 2026

(54) PBCH DESIGN FOR WIRELESS COMMUNICATION

(71) Applicant: Lenovo (United States) Inc., Morrisville, NC (US)

(72) Inventors: Karthikeyan GANESAN, Nauheim (DE); Ravi KUCHIBHOTLA, Chicago, IL (US); Ali Ramadan ALI, Kraiburg am Inn (DE)

(21) Appl. No.: 19/052,175

(22) Filed: Feb. 12, 2025

(51) Int. Cl. H04W 72/30; H04L 1/08; H04L 5/00

(52) U.S. Cl. CPC H04W 72/30; H04L 1/08; H04L 5/0053

(57) ABSTRACT

Various aspects of the present disclosure relate to a PBCH design for wireless communication. A network entity configures a master information block (MIB) with a first modification period information comprising an indication of a first time interval for updating a physical layer broadcast channel (PBCH) signal and an indication of a first quantity of PBCH signal repetitions within the first time interval. UEs of different categories (e.g., eMBB and LPWA) receive the MIB and determine their respective modification period and PBCH repetition information.

### TECHNICAL FIELD

The present disclosure relates to wireless communications, and more specifically to physical layer broadcast channel (PBCH) design including PBCH scheduling parameters for various types of devices in diverse network conditions.

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support extra-large multiple-input multiple-output (XL MIMO) technologies, such as large-scale deployments (1000+) of antenna elements, which can improve the capacity of the network, data rates, and spectral efficiency. For example, 6G radio access technologies may include an antenna element configuration of 5000 or more antenna elements in an upper mid-band frequency (e.g., 7 to 24 GHz).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on. Further, as used herein, including in the claims, a “set” may include one or more elements.

The present disclosure relates to methods, apparatus, and systems that enable streamlining the delivery of system information or PBCH scheduling parameters (e.g., master information block (MIB) transmission periodicity, a modification period, and repetitions of a PBCH signal) to various types of UEs in diverse network conditions.

A network entity may configure a MIB with a first modification period information comprising an indication of a first time interval for updating a PBCH signal and an indication of a first quantity of PBCH signal repetitions within the first time interval. UEs of different categories (e.g., enhanced mobile broadband (eMBB) and low power wide area LPWA) receive the MIB and determine their respective modification period and PBCH repetition information.

A network entity for wireless communication includes at least one memory; and at least one processor coupled with the at least one memory and configured to cause the network entity to configure a synchronization signal (SS); configure a MIB to include a system frame number (SFN) indicating a radio frame number, a first cell barring information indicating whether a UE is barred from a cell associated with the network entity, and a first modification period information comprising an indication of a first time interval for updating a PBCH signal and an indication of a first quantity of PBCH signal repetitions within the first time interval; and transmit the SS and the PBCH signal including the MIB to a plurality of UEs.

A method performed by a network entity may comprise configuring a synchronization signal (SS); configuring a MIB to include a SFN)indicating a radio frame number, a first cell barring information indicating whether a UE is barred from a cell associated with the network entity, and a first modification period information comprising an indication of a first time interval for updating a PBCH signal and an indication of a first quantity of PBCH signal repetitions within the first time interval; and transmitting the SS and the PBCH signal including the MIB to a plurality of UEs.

In some implementations of the network entity and method described herein, the plurality of UEs include an eMBB device and a LPWA network device, and the eMBB device and the LPWA network device use the same modification period included in the MIB.

In some implementations of the network entity and method described herein, the plurality of UEs further include a low-power internet of things (IoT) device.

In some implementations of the network entity and method described herein, the network entity is associated with a terrestrial network (TN) or a non-terrestrial network (NTN).

In some implementations of the network entity and method described herein, the at least one processor is configured to cause the network entity to generate the first modification period information for the MIB by accessing a table having a plurality of predefined modification periods and a plurality of predefined PBCH signal repetition counts for a corresponding modification period.

In some implementations of the network entity and method described herein, the at least one processor is configured to cause the network entity to select one of the predefined modification periods based on a cell active transmission timer period.

In some implementations of the network entity and method described herein, the at least one processor is configured to cause the network entity to implement the selected modification period in a next modification period cycle.

In some implementations of the network entity and method described herein, the at least one processor is configured to cause the network entity to select one of the predefined PBCH signal repetition counts based on a coverage requirement of supported device type.

In some implementations of the network entity and method described herein, the table includes a plurality of indices, each index being associated with one of the predefined modification periods and one of the predefined PBCH signal repetition counts, and the at least one processor is configured to cause the network entity to insert an index selected from the table in the MIB as the first modification period information.

In some implementations of the network entity and method described herein, the plurality of UEs includes at least one eMBB device and at least one non-eMBB device, the PBCH transmitted being a first PBCH signal assigned to the eMBB device, the MIB includes a second modification period information indicating a second time interval for updating a second PBCH signal and a second quantity of PBCH signal repetitions within the second time interval, and the at least one processor is configured to cause the network entity to transmit a second PBCH signal to the non-eMBB device.

In some implementations of the network entity and method described herein, the first PBCH signal is transmitted using frequency division multiplexing (FDM) and the second PBCH signal is transmitted using time division multiplexing (TDM), and the non-eMBB device is a LPWA network device or a low-power internet of things (IoT) device.

In some implementations of the network entity and method described herein, the MIB further includes a second cell barring information, a first control resource set (CORESET) (e.g., CORESET #0) information, and a second CORESET #0 information, and the first cell barring information and the first CORESET #0 are associated with an eMBB device and the second cell barring information and the second CORESET #0 are associated with a non-eMBB device.

In some implementations of the network entity and method described herein, the MIB includes a network type information indicating whether the network entity is a terrestrial network or a non-terrestrial network.

A UE for wireless communication includes at least one memory; and at least one processor coupled with the at least one memory and configured to cause the UE to receive a first PBCH signal including a MIB including a first cell barring information indicating whether a UE is barred from a cell associated with a network entity and a first modification period information comprising an indication of a first time interval for updating a first PBCH signal and an indication of a first quantity of PBCH signal repetitions within the first time interval; extracting the first modification period information from the MIB to determine the modification period and the first quantity of PBCH signal repetitions; and adjust a RACH message repetition based on the extracted first modification period information.

In some implementations of the UE and method described herein, the extracted first modification period information is an index from a table having a plurality of indices, each index being associated with one of predefined modification periods and one of predefined PBCH signal repetition counts.

In some implementations of the network entity and method described herein, the UE is an eMBB device, the MIB includes a second modification period information indicating a second time interval for updating a second PBCH signal and a second quantity of PBCH signal repetitions within the second time interval, and the first modification period information is associated with eMBB devices and the second modification period information is associated with non-eMBB devices.

In some implementations of the network entity and method described herein, the non-eMBB devices include a LPWA network device and a IoT device.

A processor for wireless communication includes at least one controller coupled with at least one memory and configured to cause the processor to configure a MIB to include a SFN indicating a radio frame number, a first cell barring information indicating whether a UE is barred from a cell associated with the network entity, and a first modification period information comprising an indication of a first time interval for updating a PBCH signal and an indication of a first quantity of PBCH signal repetitions within the first time interval; and transmit the PBCH signal including the MIB to a plurality of UEs.

### BRIEF DESCRIPTION OF THE DRAWINGS

FIG. 1 illustrates an example of a wireless communications system in accordance with aspects of the present disclosure.

FIG. 2 illustrates an example of MIB information 200 in accordance with aspects of the present disclosure.

FIG. 3 illustrates an example of a PBSCH scheduling table 300 in accordance with aspects of the present disclosure.

FIG. 4 illustrates utilization of a PBCH scheduling index in a MIB information in accordance with aspects of the present disclosure.

FIG. 5 illustrates an example of a MIB information 500 in accordance with aspects of the present disclosure.

FIG. 6A illustrates an example of a structure and configuration of a PBCH signal and synchronization signals for eMBB UEs in accordance with aspects of the present disclosure.

FIG. 6B illustrates an example of a PBCH burst structure for LPWA UEs in accordance with aspects of the present disclosure.

FIGS. 7A-7B illustrates an example of using different PBCH transmission scheduling for different UE types in accordance with aspects of the present disclosure.

FIGS. 8A and 8B illustrate an example of an MIB information 800 in accordance with aspects of the present disclosure.

FIG. 9 illustrates first-stage and second-stage MIB transmissions in accordance with aspects of the present disclosure.

FIG. 10 illustrates an example of a user equipment (UE) 1000 in accordance with aspects of the present disclosure.

FIG. 11 illustrates an example of a processor 1100 in accordance with aspects of the present disclosure.

FIG. 12 illustrates an example of a network equipment (NE) 1200 in accordance with aspects of the present disclosure.

FIG. 13 illustrate a flowcharts of method performed by a UE in accordance with aspects of the present disclosure.

FIG. 14 illustrate a flowcharts of method performed by a NE in accordance with aspects of the present disclosure.

### DETAILED DESCRIPTION

In some wireless communications systems, XL-MIMO may significantly increase a quantity of Transmit-Receive Units (TxRUs) and antenna elements used for communications, especially at upper mid-band frequencies. While this expansion in the quantity of antenna elements enables massive spatial multiplexing and narrower beamforming, it also introduces significant challenges in broadcasting system information, particularly in communication of PBCH information. For efficient communications, PBCH needs to be efficiently delivered to Enhanced Mobile Broadband (eMBB) and Low Power Wide Area (LPWA) devices under various network conditions.

Embodiments of the present disclosure relate to streamlining delivery of system information or PBCH scheduling parameters (e.g., MIB transmission periodicity, a modification period, and repetitions of a PBCH signal) or both, to various types of UEs in diverse network conditions. The different types of UEs include enhanced mobile broadband (eMBB) devices (e.g., smart phones), LPWA devices (e.g., smart meters), and low-power internet of things (IoT) devices (e.g., smartwatches). The diverse network conditions include terrestrial networks (TN) and non-terrestrial networks (NTN).

As used herein, the term “PBCH scheduling parameter” refers to any of the following: MIB transmission periodicity, modification period, repetitions of a PBCH signal, or other information relating to PBCH signal scheduling. The term “PBCH scheduling parameters” refers to any combination of two or more of these elements. Also, as used herein, a low-power IoT device/UE may be referred to as an IoT device/UE for convenience.

The MIB transmission periodicity refers to the time interval at which the MIB is broadcasted to UEs via the PBCH. This periodicity allows the UEs in the network to receive the system information for initial access and synchronization. In an implementation, the transmission follows a fixed periodic schedule, allowing devices to efficiently decode the broadcasted information without unnecessary power consumption.

The modification period refers to the time interval at which the content of the MIB may be updated. During this period, the transmitted MIB remains unchanged, ensuring stability in the system information provided to UEs. The modification period is typically several MIB transmission intervals long. A longer modification period is beneficial for low-power IoT devices, as it reduces the frequency of decoding operations and conserves battery life.

Repetitions of the PBCH signal refer to the number or quantity of times a PBCH (carrying MIB) is transmitted within a modification period to improve reliability and ensure successful reception under varying network conditions. Increasing the repetition number within a modification period enhances reception for UEs in weak signal areas, such as deep indoor environments, rural locations, or non-terrestrial networks (NTN).

Among other benefits, the embodiments disclosed herein optimize PBCH scheduling to efficiently deliver system information to diverse UEs, including eMBB, LPWA, and low-power IoT devices, across terrestrial and non-terrestrial networks. This improves coverage, enhances power efficiency, and reliable connectivity by dynamically adjusting modification periods and repetitions, reducing energy consumption, and supporting scalable wireless deployments.

Aspects of the present disclosure are described in the context of a wireless communications system.

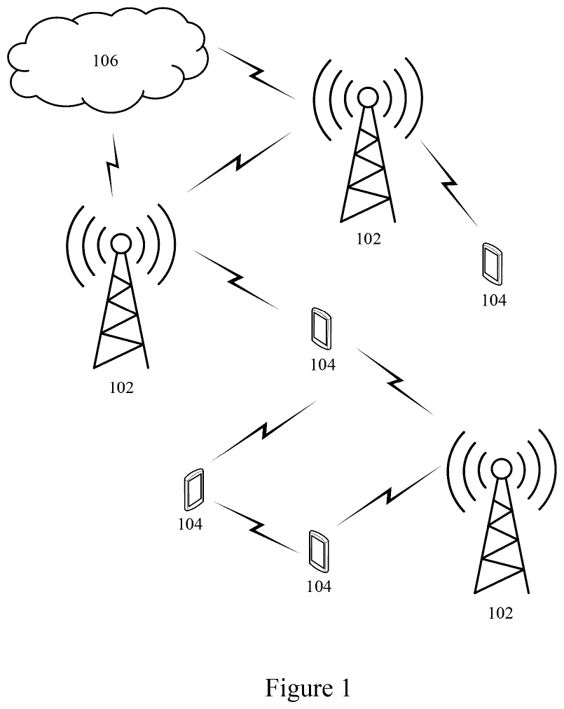

FIG. 1 illustrates an example of a wireless communications system 100 in accordance with aspects of the present disclosure. The wireless communications system 100 may include one or more network entity (NE) 102, one or more UE 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NE 102 may be dispersed throughout a geographic region to form the wireless communications system 100. One or more of the NE 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas 112 associated with the same or different radio access technologies may overlap, but the different geographic coverage areas may be associated with different NE 102.

The one or more UE 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N2, or network interface). In some implementations, the NE 102 may communicate with each other directly. In some other implementations, the NE 102 may communicate with each other or indirectly (e.g., via the CN 106. In some implementations, one or more NE 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NE 102 associated with the CN 106.

The CN 106 may communicate with a packet data network over one or more backhaul links (e.g., via an S1, N2, N2, or another network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

In an embodiment, the wireless communication system 100 provides streamlined delivery of system information or PBCH scheduling parameters or both, to various types of UEs in diverse network conditions.

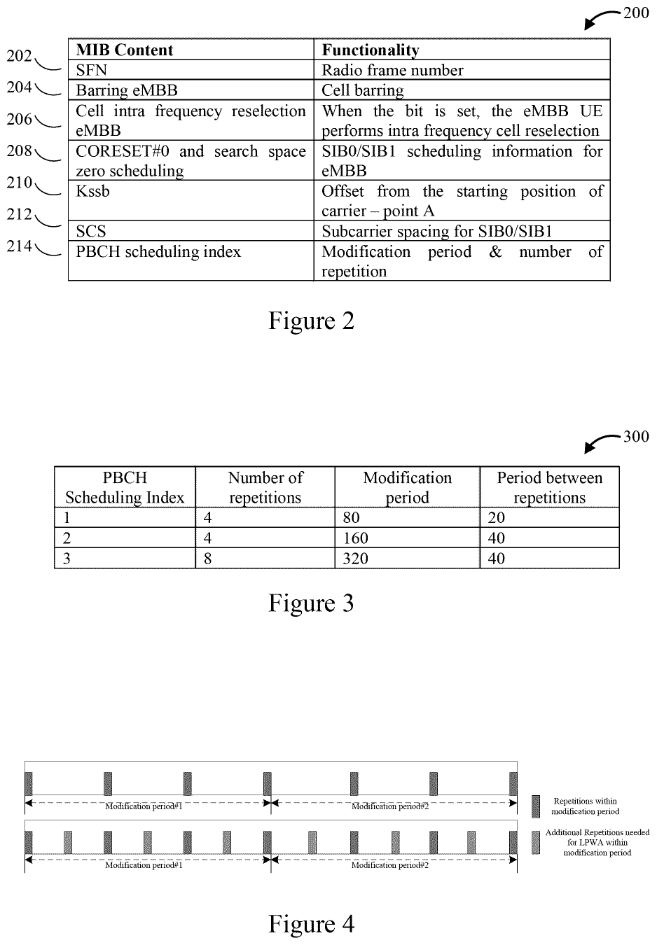

FIG. 2 illustrates an example of MIB (or MIB information or MIB Content) 200 in accordance with aspects of the present disclosure. In some embodiments, the delivery of PBCH scheduling parameters is streamlined by having the same modification period for eMBB and IoT devices while allocating a higher PBCH repetition number to IoT devices or when warranted by a network situation (e.g., when the UEs are operating in a NPN the UEs are in extended deep coverage). The PBCH scheduling parameters are provided in the MIB information 200 in an implementation. Alternatively, the PBCH scheduling parameters may be provided in SIB1.

The MIB contents or information 200 includes SFN 202 representing the radio frame number; a Barring for eMBB field 204 indicating whether access to the cell is restricted for eMBB UEs; a cell intra-frequency reselection for eMBB field 206 for determining whether an eMBB UE is to perform intra-frequency cell reselection when the corresponding bit is set; CORESET #0 and search space zero scheduling field 208 for scheduling information for System Information Block 0 (SIB0) and System Information Block 1 (SIB1); a Kssb parameter 210 for defining the offset from the carrier's starting position; a subcarrier spacing (SCS) parameter 212 for specifying the SCS configuration for SIB0 and SIB1; and a PBCH scheduling index 214 for modification period and number of repetition relating to a PBCH signal.

The MIB information 200 may be provided via the PBCH signal for eMBB devices and IoT devices supporting LPWA in diverse networks (e.g., TN and NTN). NTN support may be limited to essential emergency features such as VoIP and messaging. LPWA applications may require increased PBCH repetition to ensure reliability, and IoT devices may require a longer MIB modification period compared to eMBB to conserve power. Many PBCH parameters may be shared between eMBB and IoT devices, including the SFN, CORESET #0, Kssb, and other common signaling elements. However, IoT-specific information, such as hyper-frame structures, may be different.

The PBCH design, according to an embodiment, uses a uniform modification period for eMBB and IoT devices or uses a multiple (e.g., an integer multiple) of the eMBB modification period for the IoT modification period. The PBCH signal repetition is selected to meet a maximum coupling loss (MCL) requirements for LPWA applications. Other PBCH designs may be used to optimize performance, as will be described subsequently.

The PBCH design according to the present embodiment provides MIB information 200 via a PBCH signal to different types of devices (e.g., eMBB devices with standard coverage and IoT devices supporting LPWA communication) in different network conditions (e.g., extended, or deep coverage for TN and NTN). LPWA applications may be associated with an increased PBCH repetition within the same modification period to meet deep coverage MCL requirements exceeding 145 dB. For example, the MCL requirement for LPWA is 156 dB and 164 dB, requiring a higher PBCH repetition to ensure reliable connectivity in challenging coverage conditions.

The modification period for eMBB devices and non-eMBB devices (e.g., LPWA devices, IoT devices, or the like) can be configured to be the same. The PBCH repetition number for UEs in extended, deep, or other challenging coverage conditions may require additional PBCH repetition within a modification period to satisfy the MCL requirements. These UEs in challenging coverage conditions include eMBB devices in NTN or IoT and LPWA devices in TN or NTN. For eMBB UEs in standard coverage, the modification period can be taken as the default for UEs performing initial access, and it can be fixed in the specification, for example, at 80 ms. An additional modification period may be included in the MIB content for LPWA devices.

In an embodiment, the PBCH design for a modification period and a PBCH repetition number for each device type is indicated in the MIB information 200 included in a PBCH signal. Alternatively, the modification number and the PBCH repetition number may be included in SIB1. The modification number and the PBCH repetition number may be collectively referred to as “PBCH scheduling parameters.”

The PBCH designs above provide flexibility in network deployment, allowing PBCH transmission to be adjusted according to coverage requirements while ensuring that the modification period is indicated as part of energy-saving mechanisms.

FIG. 3 illustrates an example of a PBSCH scheduling table 300 in accordance with aspects of the present disclosure. The table 300 includes a plurality of PBCH scheduling indices, where each index is assigned a number (or a quantity) of PBCH repetitions, a modification period, and an interval between repetitions for each modification period.

The PBCH scheduling index is inserted into the MIB information 200 to provide the UEs with the PBCH scheduling parameters. Upon receiving the MIB information 200, the UEs extract the PBCH scheduling index 214 and determines the modification period and the PBCH repetition number by comparing the index to its PBCH scheduling table. Alternatively, the new modification period for MIB can be indicated in the system information broadcast, such as in SIB1.

In an implementation, eMBB UEs or eMBB devices (e.g., smart phones) may be configured to monitor the baseline repetition within the specified modification period. On the other hand, non-eMBB UEs requiring deep coverage, such as those supporting LPWA, IoT, or NTN, may be configured to monitor additional repetitions to meet more stringent coverage requirements.

Corresponding to the increased number of downlink repetitions, the number of uplink repetitions for various transmissions (including Msg3, Msg-A (RACH preamble transmission), and Msg5) may also be increased to meet deep uplink coverage needs. The number of uplink repetitions for these transmissions over PUSCH may be configured separately based on the broadcast system information, depending on the device types and network types (e.g., eMBB, LPWA, IoT, NTN, etc.).

In an embodiment, as part of network energy-saving mechanisms, the NE (e.g., NE 102) may signal the modification period in relation to the cell's active transmission duration. The NE may align PBCH transmissions, common channel transmissions, and the modification period with the cell's active transmission duration.

In an embodiment, the NE adapts the modification period starting from the next modification cycle so that idle-mode UEs monitoring PBCH can determine the updated modification period from the MIB information 200 and adjusts thereto. This enables UEs to enter extended sleep states until the next modification period, synchronized with the cell's Discontinuous Transmission (DTX) or Discontinuous Reception (DRX) active period.

FIG. 4 illustrates utilization of a PBCH scheduling index in a MIB information in accordance with aspects of the present disclosure. The NE selects a PBCH scheduling index according to network conditions and inserts the index in an MIB information (e.g., the MIB information 200). The NE sets the modification period according to the index and repeats the PBCH signal according to the PBCH repetition number corresponding to the index, as shown in the upper portion of FIG. 4. The NE may increase the PBCH repetitions for UEs supporting the LPWA or NPTN to satisfy the MCL requirements, as shown in the lower portion of FIG. 4.

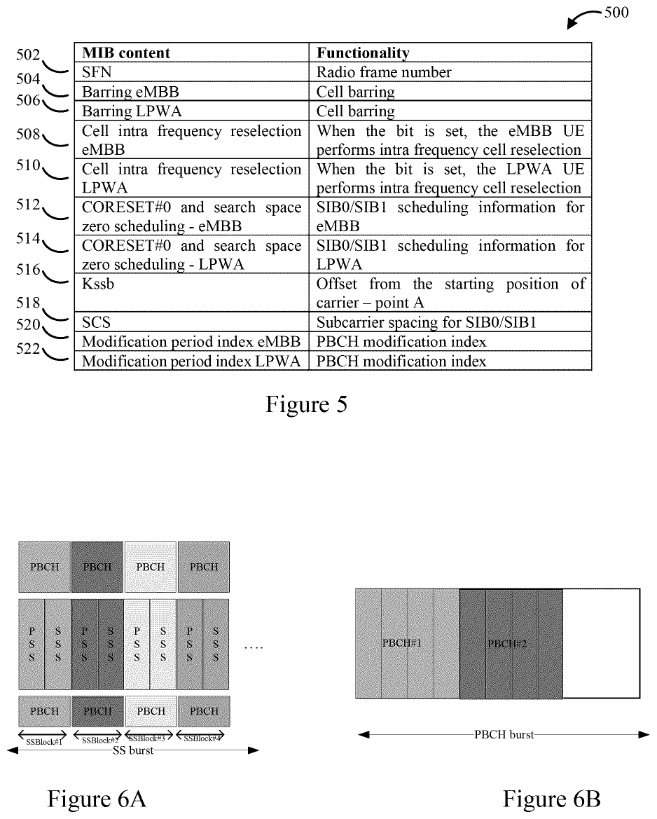

FIG. 5 illustrates an example of a MIB information 500 in accordance with aspects of the present disclosure. In an embodiment, the NE handles the PBCH scheduling differently for different UE types (e.g., eMBB UEs and IoT UEs), by providing different modification periods for different device types. For example, the PBCH signals are transmitted using Frequency Division Multiplexing (FDM) for eMBB UEs and Time Division Multiplexing (TDM) for LPWA/IoT UEs to optimize transmission. The modification period for LPWA/IoT UEs may be longer than that of eMBB UEs. In an implementation, the duration of a modification period of LPWA/IoT UEs is an integer multiple of that of eMBB UEs, thereby allowing a greater number of PBCH repetitions within the modification period to satisfy the extended deep coverage requirements of LPWA UEs.

The MIB information 500 provides different parameters for UEs of different types and allows the NE to ensure each category of UEs receives appropriate system configuration settings optimized for their use cases. For example, the eMBB UEs are provided with system configuration settings that prioritize high data rates and mobility, and the LPWA/IoT UEs are provided with system configuration settings that prioritize energy efficiency and coverage.

The MIB information 500 includes a System Frame Number (SFN) 502 for representing the radio frame number; a Barring for eMBB field 504 indicating whether access to the cell is restricted for eMBB UEs; a Barring for LPWA field 506 indicating access to the cell is restricted for eMBB UEs; a cell intra-frequency reselection for eMBB field 508 for determining whether an eMBB UE should perform intra-frequency cell reselection when the corresponding bit is set; a cell intra-frequency reselection for LPWA field 510 for determining whether an LPWA UE should perform intra-frequency cell reselection when the corresponding bit is set; CORESET #0 and search space zero scheduling for eMBB field 512 for scheduling information for SIB0 and SIB1 for eMBB UEs; CORESET #0 and search space zero scheduling for LPWA field 514 for scheduling information for SIB0 and SIB1 for LPWA UEs; a Kssb parameter 516 for defining the offset from the carrier's starting position to the SSB; a SCS parameter 518 for specifying the SCS configuration for SIB0 and SIB1; and a modification period index for eMBB 520 for modification period and number of repetition relating to a PBCH signal for eMBB UEs; a modification period index for LPWA 522 for modification period and number of repetition relating to a PBCH signal for LPWA UEs.

FIG. 6A illustrates an example of a structure and configuration of a PBCH signal and synchronization signals for eMBB UEs in accordance with aspects of the present disclosure. The NE transmits an SSB transmitted to eMBB UEs using FDM. The SSB includes a primary synchronization signal (PSS), a second synchronization signal (SSS), and a PBCH signal including the MIB information 500.

FIG. 6B illustrates an example of a PBCH burst structure for LPWA UEs in accordance with aspects of the present disclosure. The NE transmits PBCH signals using TDM. Multiple PBCH repetitions (PBCH1, PBCH2, etc.) are configured within a given modification period. The modification period for LPWA UEs can be extended to increase the PBCH repetition number within the modification period satisfy the extended deep coverage requirement of LPWA UEs. In an embodiment, the modification period for LWPA UEs is an integer multiple of the modification period of eMBB UEs.

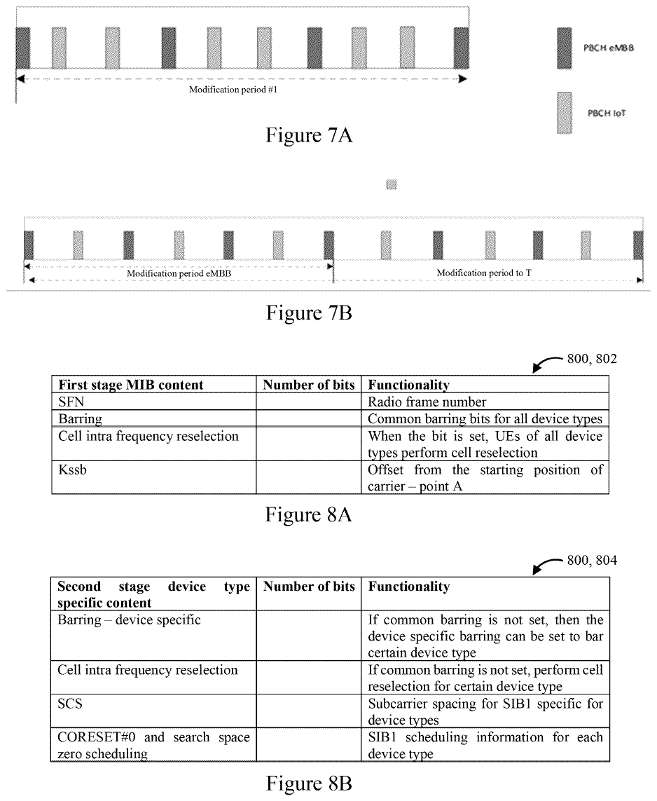

FIGS. 7A-7B illustrates an example of using different PBCH transmission scheduling for different UE types in accordance with aspects of the present disclosure. The PBCH signals may be scheduled at distinct time slots for eMBB UEs and IoT UEs. In an embodiment, the NE may schedule separate PBCH transmissions for eMBB and LPWA/IoT UEs at different occasions to optimize system performance.

The NE may assign independent PBCH transmission instances for eMBB and LPWA/IoT devices, so that each category of UEs may receive system information at different time intervals. The modification period for PBCH signals may be the same or different for eMBB and IoT UEs, depending on network requirements. The number of PBCH repetitions may vary according to different categories of UEs to accommodate different coverage needs of the UE types. For example, eMBB UEs prioritize low latency and high data throughput, and IoT UEs require higher repetitions for extended coverage and reliability.

The NE allocates distinct PBCH transmission slots for eMBB and IoT UEs to enable system resources to be allocated appropriately for different categories of UE. The separation resource allocation helps optimize network performance by addressing the differing latency, power consumption, and coverage requirements of eMBB and IoT UEs.

The NE can configure the same or different modification periods for eMBB and IoT PBCH transmissions. If the same period is used, eMBB UEs and IoT UEs receive updates at the same intervals. If different periods are used, eMBB UEs may receive updates more frequently than IoT UEs.

In an implementation, the same modification period is used but different PBCH repetition numbers are used for different types of UEs (see FIG. 7A). For example, the MOD functionality (e.g., SFN mod 10=0 for eMBB UE) may be used to periodically schedule PBCH signals. Upon receiving the PBCH, UEs extract the SFN of the MIB to determine whether the received PBCH transmission is intended for eMBB UEs, thereby optimizing PBCH scheduling for eMBB and IoT UEs.

The MOD functionality may also be used to define PBCH signals for IoT UEs, which may or may not align with PBCH signals for eMBB UEs. If the MOD value is not a multiple of the eMBB MOD, PBCH signals for IoT UEs may be transmitted independently. If the MOD value is a multiple of the eMBB MOD, PBCH signals for IoT UEs align with those of eMBB. If there is an overlap of PBCH signals for eMBB and IoT, one type of devices (e.g., eMBB UEs) may be given priority.

In another implementation, the network may employ a different modification period for PBCH signals for IoT UEs (see FIG. 7B) to increase the number of PBCH repetitions for IoT UEs to satisfy the MCL requirements for deep coverage conditions. For example, the modification period for IoT UEs is twice as long as that of the eMBB UEs.

FIGS. 8A and 8B illustrate an example of an MIB information 800 in accordance with aspects of the present disclosure. In an embodiment, the MIB information 800 includes first and second components 802 and 804 that are transmitted to UEs of different types.

The first component (or the first-stage MIB) 802 is common to eMBB and LPWA/IoT devices. The first component 802 includes an SFN, a Barring field applicable to all device types, a Cell intra-frequency cell reselection, and a Kssb that provides the frequency offset from the carrier's starting position (Point A).

The second component (the second-stage MIB) 804 is device-specific tailored for particular device types and has device-specific parameters. The second component 804 includes a device-specific Barring indicators for each device type (used if the common barring bit is not set), a Cell intra-frequency reselection field applicable to specific device types, a SCS for SIB1 tailored to different device types, and CORESET #0 and search space zero scheduling information that provides SIB1 scheduling details for each device type.

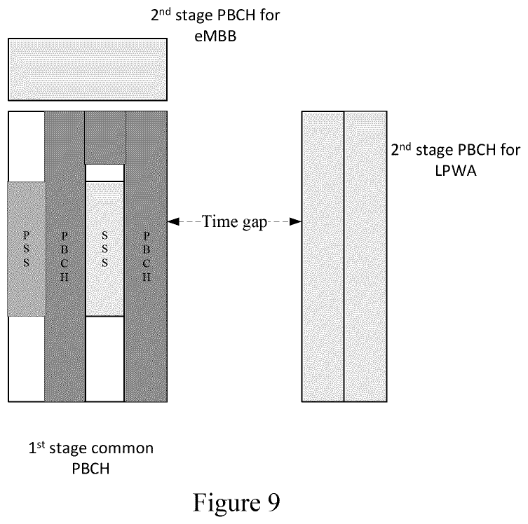

FIG. 9 illustrates first-stage and second-stage MIB transmissions in accordance with aspects of the present disclosure. The first-stage MIB transmission, shared between eMBB and IoT/LPWA UEs, is transmitted using TDM between the synchronization signal and the PBCH. To accommodate the deep coverage requirements of LPWA UEs, the modification period for the first-stage MIB may be extended, for example, to 160 ms, utilizing a robust modulation and coding scheme (e.g., π/BPSK) and increased repetitions to enhance reliability to satisfy the deep coverage requirement of LPWA UEs.

The second-stage MIB transmission, which is specific to each device type, may be handled separately for eMBB UEs and IoT/LPWA UEs. For eMBB UEs, the second-stage PBCH transmission may be multiplexed with the synchronization signal using FDM. For LPWA UEs, the second-stage PBCH may be transmitted using TDM, with a specified time offset from the last symbol of the SSB.

In another embodiment, the MIB for IoT can be transmitted with repetitions within a given modification period based on an on-demand request received via a UL request from an IoT device. A baseline MIB transmission, common to eMBB and IoT devices, may be configured with X repetitions within a modification period. The number of repetitions may be increased to Y (where Y>X) upon receiving an UL request, e.g., from an IoT device to ensure reliable MIB delivery in deep coverage situations. The UL WUS signal resource, which can be a commonly configured resource for the IoT device, may be used on-demand to request an increased number of transmission repetitions. In an implementation, the MIB content may be the same for eMBB and IoT devices with the IoT devices receiving an increased MIB transmission repetition within the modification period to satisfy deep coverage requirements. In another implementation, the MIB content for eMBB and IoT devices may be split into a first part and a second part, where the second part of the PBCH for IoT is transmitted using an on-demand, higher repetition for deep coverage situations. In yet another implementation, the MIB content for eMBB and IoT may differ in contents and periodicity, with the MIB for IOT configured for transmission during the on-demand request. In another implementation, UL WUS can be separately configured for eMBB and IoT MIB on-demand transmission.

In another embodiment, a MIB information may include an indicator specifying whether the transmission originates from a TN or NTN. The MIB information may include an indication specifying whether the transmission originates from a TN or a NTN, such as a satellite or a high-altitude platform station (HAPS), for LPWA applications. This indication is used to provide a sufficient number of uplink repetitions to achieve coverage parity with the downlink in NTN scenarios, particularly for emergency services such as voice calls and messaging.

In yet another embodiment, the network type may be indicated using synchronization signal (SS) sequences (e.g., the cell ID) by reserving specific sequences for NTN and LPWA. Once a UE identifies the network type from either the synchronization signal or the MIB, it can adapt its uplink transmission parameters accordingly. The adaptation may include adjusting the number of repetitions for Msg3, selecting an RACH format with a longer guard period, and configuring the Random Access Response (RAR) window to accommodate the characteristics of the NTN and LPWA environments.

Alternatively, the network type can be indicated using system information broadcast (SIB) rather than the MIB. In such a case, the number of repetitions for Msg3, the RACH format, and the RAR window configuration may also be provided in the broadcast system information, thereby providing flexible adaptation of uplink transmission parameters and robust connectivity for UEs operating in NTN and LPWA scenarios.

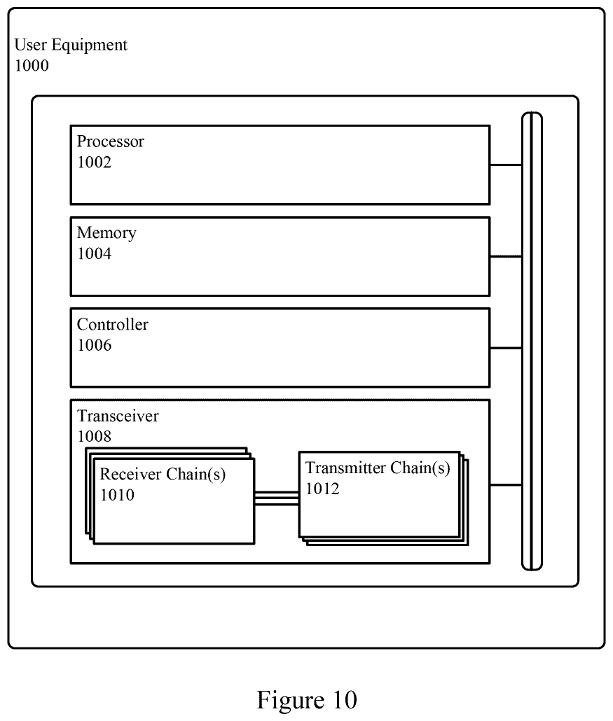

FIG. 10 illustrates an example of a UE 1000 in accordance with aspects of the present disclosure. The UE 1000 may include a processor 1002, a memory 1004, a controller 1006, and a transceiver 1008. The processor 1002, the memory 1004, the controller 1006, or the transceiver 1008, or various combinations thereof or various components thereof may be examples of means for performing various aspects of the present disclosure as described herein. These components may be coupled (e.g., operatively, communicatively, functionally, electronically, electrically) via one or more interfaces.

The processor 1002, the memory 1004, the controller 1006, or the transceiver 1008, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1002 may include an intelligent hardware device (e.g., a general-purpose processor, a DSP, a CPU, an ASIC, an FPGA, or any combination thereof). In some implementations, the processor 1002 may be configured to operate the memory 1004. In some other implementations, the memory 1004 may be integrated into the processor 1002. The processor 1002 may be configured to execute computer-readable instructions stored in the memory 1004 to cause the UE 1000 to perform various functions of the present disclosure.

The memory 1004 may include volatile or non-volatile memory. The memory 1004 may store computer-readable, computer-executable code including instructions when executed by the processor 1002 cause the UE 1000 to perform various functions described herein. The code may be stored in a non-transitory computer-readable medium such the memory 1004 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1002 and the memory 1004 coupled with the processor 1002 may be configured to cause the UE 1000 to perform one or more of the functions described herein (e.g., executing, by the processor 1002, instructions stored in the memory 1004). For example, the processor 1002 may support wireless communication at the UE 1000 in accordance with examples as disclosed herein.

The controller 1006 may manage input and output signals for the UE 1000. The controller 1006 may also manage peripherals not integrated into the UE 1000. In some implementations, the controller 1006 may utilize an operating system such as iOS®, ANDROID®, WINDOWS®, or other operating systems. In some implementations, the controller 1006 may be implemented as part of the processor 1002.

In some implementations, the UE 1000 may include at least one transceiver 1008. In some other implementations, the UE 1000 may have more than one transceiver 1008. The transceiver 1008 may represent a wireless transceiver. The transceiver 1008 may include one or more receiver chains 1010, one or more transmitter chains 1012, or a combination thereof.

A receiver chain 1010 may be configured to receive signals (e.g., control information, data, packets) over a wireless medium. For example, the receiver chain 1010 may include one or more antennas for receive the signal over the air or wireless medium. The receiver chain 1010 may include at least one amplifier (e.g., a low-noise amplifier (LNA)) configured to amplify the received signal. The receiver chain 1010 may include at least one demodulator configured to demodulate the receive signal and obtain the transmitted data by reversing the modulation technique applied during transmission of the signal. The receiver chain 1010 may include at least one decoder for decoding the processing the demodulated signal to receive the transmitted data.

A transmitter chain 1012 may be configured to generate and transmit signals (e.g., control information, data, packets). The transmitter chain 1012 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1012 may also include at least one power amplifier configured to amplify the modulated signal to an appropriate power level suitable for transmission over the wireless medium. The transmitter chain 1012 may also include one or more antennas for transmitting the amplified signal into the air or wireless medium.

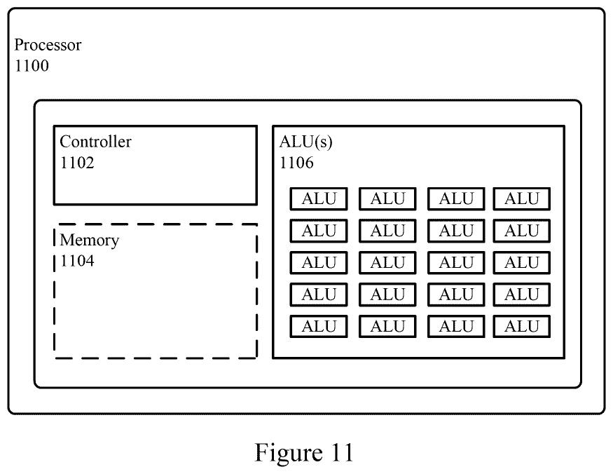

FIG. 11 illustrates an example of a processor 1100 in accordance with aspects of the present disclosure. The processor 1100 may be an example of a processor configured to perform various operations in accordance with examples as described herein. The processor 1100 may include a controller 1102 configured to perform various operations in accordance with examples as described herein. The processor 1100 may optionally include at least one memory 1104, which may be, for example, an L1/L2/L3 cache. Additionally, or alternatively, the processor 1100 may optionally include one or more arithmetic-logic units (ALUs) 1106. One or more of these components may be in electronic communication or otherwise coupled (e.g., operatively, communicatively, functionally, electronically, electrically) via one or more interfaces (e.g., buses).

The processor 1100 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 1100) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 1102 may be configured to manage and coordinate various operations (e.g., signaling, receiving, obtaining, retrieving, transmitting, outputting, forwarding, storing, determining, identifying, accessing, writing, reading) of the processor 1100 to cause the processor 1100 to support various operations in accordance with examples as described herein. For example, the controller 1102 may operate as a control unit of the processor 1100, generating control signals that manage the operation of various components of the processor 1100. These control signals include enabling or disabling functional units, selecting data paths, initiating memory access, and coordinating timing of operations.

The controller 1102 may be configured to fetch (e.g., obtain, retrieve, receive) instructions from the memory 1104 and determine subsequent instruction(s) to be executed to cause the processor 1100 to support various operations in accordance with examples as described herein. The controller 1102 may be configured to track memory address of instructions associated with the memory 1104. The controller 1102 may be configured to decode instructions to determine the operation to be performed and the operands involved. For example, the controller 1102 may be configured to interpret the instruction and determine control signals to be output to other components of the processor 1100 to cause the processor 1100 to support various operations in accordance with examples as described herein. Additionally, or alternatively, the controller 1102 may be configured to manage flow of data within the processor 1100. The controller 1102 may be configured to control transfer of data between registers, arithmetic logic units (ALUs), and other functional units of the processor 1100.

The memory 1104 may include one or more caches (e.g., memory local to or included in the processor 1100 or other memory, such RAM, ROM, DRAM, SDRAM, SRAM, MRAM, flash memory, etc. In some implementations, the memory 1104 may reside within or on a processor chipset (e.g., local to the processor 1100). In some other implementations, the memory 1104 may reside external to the processor chipset (e.g., remote to the processor 1100).

The memory 1104 may store computer-readable, computer-executable code including instructions that, when executed by the processor 1100, cause the processor 1100 to perform various functions described herein. The code may be stored in a non-transitory computer-readable medium such as system memory or another type of memory. The controller 1102 and/or the processor 1100 may be configured to execute computer-readable instructions stored in the memory 1104 to cause the processor 1100 to perform various functions. For example, the processor 1100 and/or the controller 1102 may be coupled with or to the memory 1104, the processor 1100, the controller 1102, and the memory 1104 may be configured to perform various functions described herein. In some examples, the processor 1100 may include multiple processors and the memory 1104 may include multiple memories. One or more of the multiple processors may be coupled with one or more of the multiple memories, which may, individually or collectively, be configured to perform various functions herein.

The one or more ALUs 1106 may be configured to support various operations in accordance with examples as described herein. In some implementations, the one or more ALUs 1106 may reside within or on a processor chipset (e.g., the processor 1100). In some other implementations, the one or more ALUs 1106 may reside external to the processor chipset (e.g., the processor 1100). One or more ALUs 1106 may perform one or more computations such as addition, subtraction, multiplication, and division on data. For example, one or more ALUs 1106 may receive input operands and an operation code, which determines an operation to be executed. One or more ALUs 1106 be configured with a variety of logical and arithmetic circuits, including adders, subtractors, shifters, and logic gates, to process and manipulate the data according to the operation. Additionally, or alternatively, the one or more ALUs 1106 may support logical operations such as AND, OR, exclusive-OR (XOR), not-OR (NOR), and not-AND (NAND), enabling the one or more ALUs 1106 to handle conditional operations, comparisons, and bitwise operations.

The processor 1100 may support wireless communication in accordance with examples as disclosed herein.

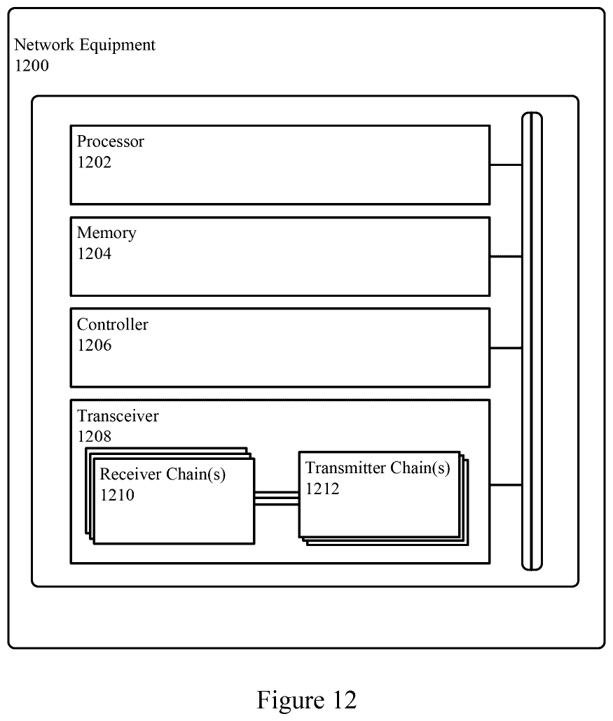

FIG. 12 illustrates an example of a NE 1200 in accordance with aspects of the present disclosure. The NE 1200 may include a processor 1202, a memory 1204, a controller 1206, and a transceiver 1208. The processor 1202, the memory 1204, the controller 1206, or the transceiver 1208, or various combinations thereof or various components thereof may be examples of means for performing various aspects of the present disclosure as described herein. These components may be coupled (e.g., operatively, communicatively, functionally, electronically, electrically) via one or more interfaces.

The processor 1202, the memory 1204, the controller 1206, or the transceiver 1208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 1202 may include an intelligent hardware device (e.g., a general-purpose processor, a DSP, a CPU, an ASIC, an FPGA, or any combination thereof). In some implementations, the processor 1202 may be configured to operate the memory 1204. In some other implementations, the memory 1204 may be integrated into the processor 1202. The processor 1202 may be configured to execute computer-readable instructions stored in the memory 1204 to cause the NE 1200 to perform various functions of the present disclosure.

The memory 1204 may include volatile or non-volatile memory. The memory 1204 may store computer-readable, computer-executable code including instructions when executed by the processor 1202 cause the NE 1200 to perform various functions described herein. The code may be stored in a non-transitory computer-readable medium such the memory 1204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 1202 and the memory 1204 coupled with the processor 1202 may be configured to cause the NE 1200 to perform one or more of the functions described herein (e.g., executing, by the processor 1202, instructions stored in the memory 1204). For example, the processor 1202 may support wireless communication at the NE 1200 in accordance with examples as disclosed herein. The NE 1200 may be configured to support a means for configuring a MIB to include a first modification period information comprising an indication of a first time interval for updating a PBCH signal and an indication of a first quantity of PBCH signal repetitions within the first time interval and transmitting the PBCH signal including the MIB to a plurality of UEs.

The controller 1206 may manage input and output signals for the NE 1200. The controller 1206 may also manage peripherals not integrated into the NE 1200. In some implementations, the controller 1206 may utilize an operating system such as iOS®, ANDROID®, WINDOWS®, or other operating systems. In some implementations, the controller 1206 may be implemented as part of the processor 1202.

In some implementations, the NE 1200 may include at least one transceiver 1208. In some other implementations, the NE 1200 may have more than one transceiver 1208. The transceiver 1208 may represent a wireless transceiver. The transceiver 1208 may include one or more receiver chains 1210, one or more transmitter chains 1212, or a combination thereof.

A receiver chain 1210 may be configured to receive signals (e.g., control information, data, packets) over a wireless medium. For example, the receiver chain 1210 may include one or more antennas for receive the signal over the air or wireless medium. The receiver chain 1210 may include at least one amplifier (e.g., a low-noise amplifier (LNA)) configured to amplify the received signal. The receiver chain 1210 may include at least one demodulator configured to demodulate the receive signal and obtain the transmitted data by reversing the modulation technique applied during transmission of the signal. The receiver chain 1210 may include at least one decoder for decoding the processing the demodulated signal to receive the transmitted data.

A transmitter chain 1212 may be configured to generate and transmit signals (e.g., control information, data, packets). The transmitter chain 1212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 1212 may also include at least one power amplifier configured to amplify the modulated signal to an appropriate power level suitable for transmission over the wireless medium. The transmitter chain 1212 may also include one or more antennas for transmitting the amplified signal into the air or wireless medium.

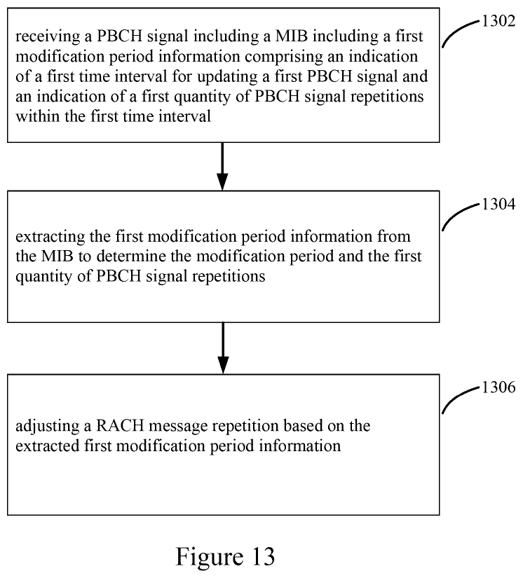

FIG. 13 illustrates a flowchart of a method in accordance with aspects of the present disclosure. The operations of the method may be implemented by a UE as described herein. In some implementations, the UE may execute a set of instructions to control the function elements of the UE to perform the described functions.

At 1302, the method may include receiving a PBCH signal including a MIB including a first modification period information comprising an indication of a first time interval for updating a first PBCH signal and an indication of a first quantity of PBCH signal repetitions within the first time interval. The operations of 1302 may be performed in accordance with examples as described herein. In some implementations, aspects of the operations of 1302 may be performed by a UE as described with reference to FIG. 10.

At 1304, the method may include extracting the first modification period information from the MIB to determine the modification period and the first quantity of PBCH signal repetitions. The operations of 1304 may be performed in accordance with examples as described herein. In some implementations, aspects of the operations of 1304 may be performed by a UE as described with reference to FIG. 10.

At 1306, the method may include adjusting a RACH message repetition based on the extracted first modification period information. The operations of 1306 may be performed in accordance with examples as described herein. In some implementations, aspects of the operations of 1306 may be performed a UE as described with reference to FIG. 10.

It should be noted that the method described herein describes A possible implementation, and that the operations and the steps may be rearranged or otherwise modified and that other implementations are possible.

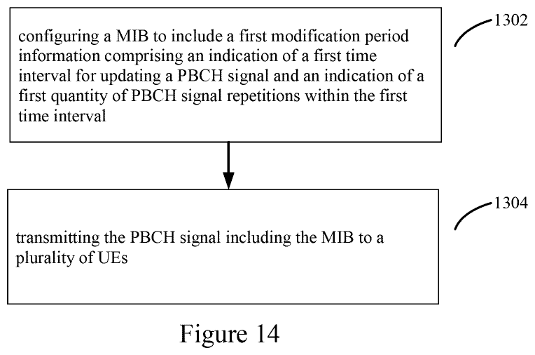

FIG. 14 illustrates a flowchart of a method in accordance with aspects of the present disclosure. The operations of the method may be implemented by a NE as described herein. In some implementations, the NE may execute a set of instructions to control the function elements of the NE to perform the described functions.

At 1402, the method may include configuring a MIB to include a first modification period information comprising an indication of a first time interval for updating a PBCH signal and an indication of a first quantity of PBCH signal repetitions within the first time interval. The operations of 1402 may be performed in accordance with examples as described herein. In some implementations, aspects of the operations of 1402 may be performed by a NE as described with reference to FIG. 12.

At 1404, the method may include transmitting the PBCH signal including the MIB to a plurality of UEs. The operations of 1404 may be performed in accordance with examples as described herein. In some implementations, aspects of the operations of 1404 may be performed by a NE as described with reference to FIG. 12.

It should be noted that the method described herein describes A possible implementation, and that the operations and the steps may be rearranged or otherwise modified and that other implementations are possible.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A network entity for wireless communication, comprising:
at least one memory; and
at least one processor coupled with the at least one memory and configured to cause the network entity to:
configure a synchronization signal (SS);
configure a master information block (MIB) to include a system frame number (SFN) indicating a radio frame number, a first cell barring information indicating whether a user equipment (UE) is barred from a cell associated with the network entity, and a first modification period information comprising an indication of a first time interval for updating a physical layer broadcast channel (PBCH) signal and an indication of a first quantity of PBCH signal repetitions within the first time interval; and
transmit the SS and the PBCH signal including the MIB to a plurality of user equipment (UEs).

2. The network entity of claim 1, wherein the plurality of UEs include an enhanced mobile broadband (eMBB) device and a low power wide area (LPWA) network device, and
wherein the eMBB device and the LPWA network device use the same modification period included in the MIB.

3. The network entity of claim 2, wherein the plurality of UEs further include a low-power internet of things (IoT) device.

4. The network entity of claim 2, wherein the network entity is associated with a terrestrial network (TN) or a non-terrestrial network (NTN).

5. The network entity of claim 1, wherein the at least one processor is configured to cause the network entity to generate the first modification period information for the MIB by accessing a table having a plurality of predefined modification periods and a plurality of predefined PBCH signal repetition counts for a corresponding modification period.

6. The network entity of claim 5, wherein the at least one processor is configured to cause the network entity to select one of the predefined modification periods based on a cell active transmission timer period.

7. The network entity of claim 6, wherein the at least one processor is configured to cause the network entity to implement the selected modification period in a next modification period cycle.

8. The network entity of claim 5, wherein the at least one processor is configured to cause the network entity to select one of the predefined PBCH signal repetition counts based on a coverage requirement of supported device type.

9. The network entity of claim 5, wherein the table includes a plurality of indices, each index being associated with one of the predefined modification periods and one of the predefined PBCH signal repetition counts, and
wherein the at least one processor is configured to cause the network entity to insert an index selected from the table in the MIB as the first modification period information.

10. The network entity of claim 1, wherein the plurality of UEs includes at least one enhanced mobile broadband (eMBB) device and at least one non-eMBB device, the PBCH transmitted being a first PBCH signal assigned to the eMBB device,
wherein the MIB includes a second modification period information indicating a second time interval for updating a second PBCH signal and a second quantity of PBCH signal repetitions within the second time interval, and
wherein the at least one processor is configured to cause the network entity to transmit a second PBCH signal to the non-eMBB device.

11. The network entity of claim 10, wherein the first PBCH signal is transmitted using frequency division multiplexing (FDM) and the second PBCH signal is transmitted using time division multiplexing (TDM), and
wherein the non-eMBB device is a low power wide area (LPWA) network device or a low-power internet of things (IoT) device.

12. The network entity of claim 10, wherein the MIB further includes a second cell barring information, a first CORESET #0 information, and a second CORESET #0 information, and
wherein the first cell barring information and the first CORESET #0 are associated with an eMBB device and the second cell barring information and the second CORESET #0 are associated with a non-eMBB device.

13. The network entity of claim 1, wherein the MIB includes a network type information indicating whether the network entity is a terrestrial network or a non-terrestrial network.

14. A user equipment (UE) for wireless communication, comprising:
at least one memory; and
at least one processor coupled with the at least one memory and configured to cause the UE to:
receive a first physical layer broadcast channel (PBCH) signal including a master information block (MIB) including a first cell barring information indicating whether a user equipment (UE) is barred from a cell associated with a network entity and a first modification period information comprising an indication of a first time interval for updating a first physical layer broadcast channel (PBCH) signal and an indication of a first quantity of PBCH signal repetitions within the first time interval;
extracting the first modification period information from the MIB to determine the modification period and the first quantity of PBCH signal repetitions; and
adjust a RACH message repetition based on the extracted first modification period information.

15. The UE of claim 14, wherein the extracted first modification period information is an index from a table having a plurality of indices, each index being associated with one of predefined modification periods and one of predefined PBCH signal repetition counts.

16. The UE of claim 14, wherein the UE is an enhanced mobile broadband (eMBB) device,
wherein the MIB includes a second modification period information indicating a second time interval for updating a second PBCH signal and a second quantity of PBCH signal repetitions within the second time interval, and
wherein the first modification period information is associated with eMBB devices and the second modification period information is associated with non-eMBB devices.

17. The UE of claim 16, wherein the non-eMBB devices include a low power wide area (LPWA) network device and a low-power internet of things (IoT) device.

18. A method performed by a network entity, the method comprising:
configuring a synchronization signal (SS);
configuring a master information block (MIB) to include a system frame number (SFN) indicating a radio frame number, a first cell barring information indicating whether a user equipment (UE) is barred from a cell associated with the network entity, and a first modification period information comprising an indication of a first time interval for updating a physical layer broadcast channel (PBCH) signal and an indication of a first quantity of PBCH signal repetitions within the first time interval; and
transmitting the SS and the PBCH signal including the MIB to a plurality of user equipment (UEs).

19. The method of claim 18, wherein the plurality of UEs include an enhanced mobile broadband (eMBB) device and a low power wide area (LPWA) network device, and
wherein the eMBB device and the LPWA network device use the same modification period included in the MIB.

20. A processor for wireless communication, the processor comprising:
at least one controller coupled with at least one memory and configured to cause the processor to:
configure a master information block (MIB) to include a system frame number (SFN) indicating a radio frame number, a first cell barring information indicating whether a user equipment (UE) is barred from a cell associated with the network entity, and a first modification period information comprising an indication of a first time interval for updating a physical layer broadcast channel (PBCH) signal and an indication of a first quantity of PBCH signal repetitions within the first time interval; and
transmit the PBCH signal including the MIB to a plurality of user equipment (UEs).
